(19) United States
(12) Patent Application Publication
(10) Pub. No.: US 2010/0181082 A1
(43) Pub. Date: Jul. 22, 2010

(54) System For Improving Water Delivery Time In Dry Pipe Sprinkler System

(75) Inventor: Brian S. Green, Nashville, MI (US)

Correspondence Address: HARNESS, DICKEY & PIERCE, P.L.C., P.O. BOX 828, BLOOMFIELD HILLS, MI, 48303, US

(73) Assignee: THE VIKING CORPORATION, Hastings, MI (US)

(21) Appl. No.: 12/689,766

(22) Filed: Jan. 19, 2010

Related U.S. Application Data
(60) Provisional application No. 61/146,475, filed on Jan. 22, 2009.

(51) Int. Cl. A62C 35/00

(52) U.S. Cl. 169/17

(57) ABSTRACT

A dry sprinkler system, includes a fire extinguishing fluid supply line connected to a pressurized fire extinguishing fluid source. A plurality of fire protection sprinklers are connected to the fire extinguishing fluid supply line, each of the plurality of fire protection sprinklers including a sprinkler body having a stepped orifice. A control system is operably connected to the pressurized fire extinguishing fluid source and the fire extinguishing fluid supply line. The control system is configured to maintain the fire extinguishing fluid supply line dry during a non-activated condition and to forward a fire extinguishing fluid to the fire extinguishing fluid supply line from the pressurized fire extinguishing fluid source upon activation of one of the plurality of fire protection sprinklers. The use of stepped orifice sprinklers allows for a quicker discharge of air from the fluid supply line as compared to typical tapered orifice sprinklers, thereby providing improved water delivery time.

### CROSS-REFERENCE TO RELATED APPLICATIONS

This application claims the benefit of U.S. Provisional Application No. 61/146,475, filed on Jan. 22, 2009, the entire disclosure of which is incorporated herein by reference.

### FIELD

The present disclosure relates to a system for improving water delivery time in a dry pipe sprinkler system.

### BACKGROUND

This section provides background information related to the present disclosure which is not necessarily prior art.

Per NFPA (National Fire Protection Association) 13 a Dry Pipe Sprinkler System is defined as “A sprinkler system employing automatic sprinklers that are attached to a piping system containing air or nitrogen under pressure, the release of which (as from the opening of a sprinkler) permits the water pressure to open a valve known as a dry pipe valve, and the water then flows into the piping system and out the opened sprinklers.” There are limits to the size, or volume, of dry pipe systems per NFPA 13. The code limits the size of the system to minimize the time necessary for the water to travel from the dry pipe valve to the open sprinkler. There are three conditions that limit the size of the dry pipe system:

A system supported by one dry pipe valve can be designed up to a volume of 500 gallons.

A system supported by one dry pipe valve can be designed up to a volume of 750 gallons if a quick-opening device is used. A quick-opening device is defined in Section 7.2.4 of the 2007 Automatic Sprinkler Systems Handbook, as consisting “primarily of accelerators and exhausters. Accelerators cause the dry pipe valve to operate more quickly by redirecting system air into the valve's intermediate chamber, thus allowing water pressure to expel air from the activated sprinklers at a faster rate. Exhausters accelerate the rate at which air is discharged to atmosphere, thus reducing the time it takes for the dry pipe valve to operate and the time it takes for water to reach the open sprinklers.”

A system supported by one dry pipe valve can be of any volume if the system is designed to deliver water to the system test connection in not more than 60 seconds. NFPA 13 Section 7.2 provides design requirements for a dry pipe system while NFPA 13 Section 7.3 provides design requirements of a pre-action system which are each herein incorporated by reference.

The selection of the proper sprinkler for use on double interlock pre-action and dry pipe sprinkler systems requires consideration of several factors in addition to those of the basic wet pipe system. Potential freezing temperatures and sediment buildup within the sprinkler system piping compels NFPA 13, Standard for the Installation of Sprinkler Systems, to restrict the sprinkler portions for these systems. Within the 2007 edition of NFPA 13, section 7.2.2 lists acceptable sprinklers for use on dry systems, and section 7.3.2.5 describes those sprinklers that are acceptable for pre-action systems.

### SUMMARY

This section provides a general summary of the disclosure, and is not a comprehensive disclosure of its full scope or all of its features.

Through testing and research, an additional consideration has been discovered for those systems where water delivery times are required for the sprinkler system by the installation standard, or where accelerated water delivery times are desired for high value occupancies, such as telecommunication or computer data centers. Historically, sprinkler system design includes complete hydraulic calculations and evaluation of sprinkler head performance based on the discharge coefficient (K-Factor) for the flow of water. Very little consideration has been given to the performance and discharge of air through a sprinkler. The discovery of the present disclosure is that the internal shape of the sprinkler orifice can have a significant effect on the sprinkler's ability to rapidly discharge air, even if the discharge coefficient for water remains the same.

Two types of orifices used in automatic sprinklers are referred to as tapered orifice and stepped orifice (FIG. 3). Recent experiments and testing have shown that a greater amount of air can flow through a stepped orifice per second than a tapered orifice. Accordingly, allowing a greater amount of air to discharge through the sprinkler allows a double interlock pre-action or dry pipe sprinkler system utilizing sprinklers with a stepped orifice will operate faster than those systems utilizing sprinklers with a tapered orifice. For example, a sprinkler that has a K-factor of 5.6 with a stepped orifice will discharge air faster than a sprinkler with a K-factor of 5.6 that has a tapered orifice.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective, partial cut away view of an enclosure having a dry sprinkler system according to the principles of the present disclosure;

FIG. 2 is a cross-sectional view of an exemplary sprinkler for use with a dry sprinkler system according to the principles of the present disclosure;

FIG. 3 is a comparative schematic view of a stepped orifice and a tapered orifice of a sprinkler; and

FIG. 4 is a comparative schematic view illustrating the water flow through a stepped orifice and a tapered orifice of a sprinkler.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

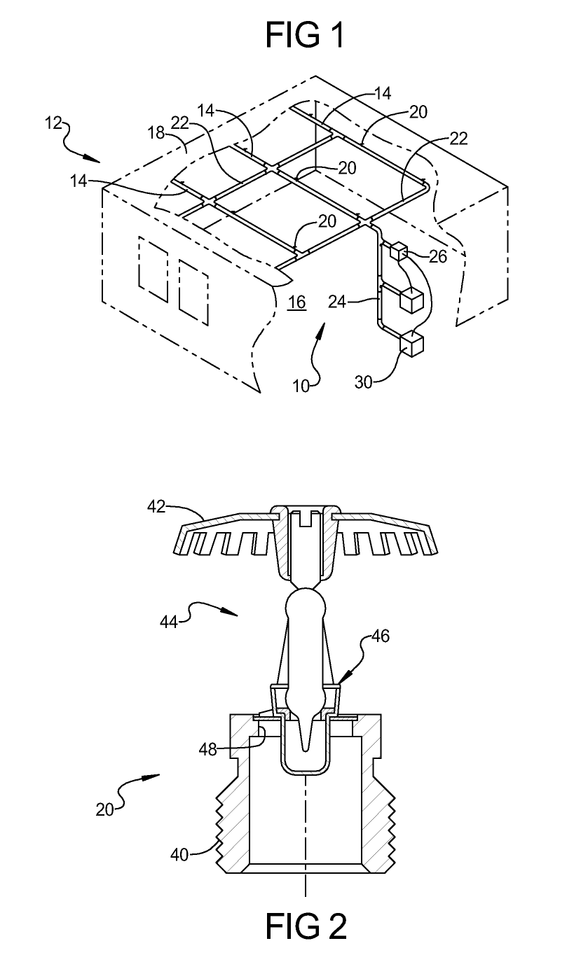

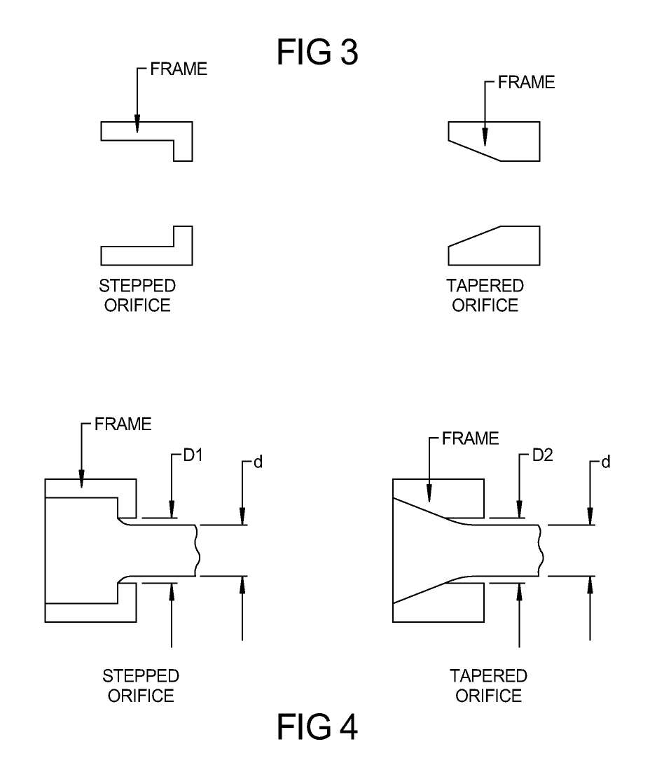

Referring now to FIG. 1, there is shown a dry sprinkler system 10 positioned within an enclosure 12. Dry sprinkler system 10 generally includes one or more fluid supply lines 14 positioned within an enclosure 12, a pre-selected distance above floor 16 and below ceiling 18. Placed at regular intervals along supply lines 14 are sprinklers 20. As illustrated in FIG. 1, sprinklers 20 are depicted as projecting upward toward ceiling 18 of enclosure 12, and thus are upright sprinklers. However, it will be recognized by those with ordinary skill in the art that sprinklers 20 may be secured to the underside of supply lines 14 and depend therefrom towards floor 16, and in such an embodiment be described as pendent sprinklers. Sprinklers 20 are secured to supply lines 14 and are in fluid communication therewith. Supply lines 14 are in fluid communication with one another by one or more cross supply lines 22 running generally orthogonal to supply lines 14.

Supply lines 14 are in fluid communication with a system line 24 which is operably connected to a control system 26. Control system 26 is in turn connected to a pressurized water source 30. Under non-activated conditions, control system 26 maintains constant air pressure in supply lines 14. When the temperature within enclosure 12 is elevated to a pre-selected value indicative of a fire, sprinklers 20 are actuated, which in turn relieves air pressure from supply lines 14 through activated sprinklers resulting in system activation and the release of pressurized water throughout the supply lines 14 and cross supply lines 22. This water is subsequently expelled from sprinklers 20 in an attempt to control or extinguish a fire. The dry sprinkler system 10 is merely generally described and can take on many arrangements which are well known in the art.

Dry sprinkler system sprinkler 20 includes a sprinkler frame or body 40, and a fluid deflector 42 positioned a pre-selected distance from top region of the sprinkler body 40 by a frame or yoke as is generally well known in the art. A thermally sensitive trigger 44 is mounted between sprinkler body 40 and deflector 42 for securing a plug 46 in an orifice 48 of the sprinkler body 40. The thermally sensitive trigger 44 can be of any known type including glass bulb, linkage and plunger type triggers. The trigger 44 can have any desired response temperature and response time index (RTI). The deflector 42 can have many shapes and is designed to provide a desired water distribution pattern so as to effectively control and/or suppress a fire.

In the design of an automatic sprinkler, the designer must create a waterway at a certain K-factor, such that the formula Q=K√P holds true for a large pressure range, typically 7-100 PSI (where Q=GPM of water, P=pressure in PSI, and K=K-factor). The governing equation for an orifice design, with water is:

K=29.83*c*D̂2

Where:

K=K-factor

c=orifice coefficient

D=orifice diameter (inches).

The orifice coefficient typically has a value of 0.65 for a stepped orifice and 0.93 for a tapered orifice. The orifice coefficient is a measure of an orifice's efficiency. As one can see from the governing equation, for a given K-factor, the diameter of a stepped orifice will be larger than the diameter of a tapered orifice. This can be seen in FIG. 4. D1 for the stepped orifice is greater than D2 of the tapered orifice. For a given K-factor, the diameter of the water column leaving the orifice (d) is the same for both a stepped orifice and a tapered orifice for water. The diameter (d) would also be known as the vena contracta. The vena contracta is the limiting diameter for water to flow through. Said another way, for a given K-factor, both a stepped and tapered orifice will have the same vena contracta diameter, for water. The orifice coefficient (c) is the measure of an orifice's efficiency with relation to the orifice frame diameter.

The orifice coefficient (c) is dependent on the fluid passing through the orifice. In the case of air passing through the sprinkler orifice, the orifice coefficients will be different from water, along with the vena contracta diameters.

When air passes through an orifice, the amount of air that can pass through a given orifice is less dependent on configuration and more dependent on the orifice area. Table 1 lists the diameters and areas for tapered and stepped orifice sprinklers for specific exemplary K-factors. As can be seen in Table 1, the increase in orifice area from a tapered to a stepped orifice is significant. It should be understood that sprinklers having other K-factors (larger or smaller) can be used, based upon the desired application.

TABLE 1

| | 5.6K | | 8.0K | | 11.2K | |
|---|---|---|---|---|---|---|
| | Tapered | Stepped | Tapered | Stepped | Tapered | Stepped |
| Diameter | 0.438 | 0.506 | 0.528 | 0.607 | 0.623 | 0.76 |
| Area in\hat{ }2 | 0.151 | 0.201 | 0.219 | 0.289 | 0.305 | 0.454 |

| | | | |
|---|---|---|---|
| % Area | 33% | 32% | 49% |
| Increase | | | |

Note:
8.0K and 11.2K stepped orifice are theoretical.

The amount of air-flow through an orifice is mostly proportional to its area; the configuration effects of the orifice are much less important for the passage of air than water. The physics of water delivery to an inspector's test involve many factors. A stepped orifice can greatly increase the air-flow rates through the sprinkler and allow a water delivery improvement of about 15% or more when using sprinklers of the same K-factor.

When sprinklers on double interlock preaction and dry pipe systems operate due to a fire, air (not water) from within the dry pipe system will initially be discharged from the open sprinkler. Because there is a delay in water delivery, the fire is expected to be larger when the water reaches the fire than it would have been on a typical wet pipe system where there is no delivery delay. The larger fire will cause more sprinklers to operate, which will increase the amount of water that is necessary to control the fire. To account for the additional sprinklers that may open, NFPA 13 requires the design area used in the hydraulic calculations to be increased by 30% to ensure the necessary water is available for fire control.

Selecting sprinklers that use a stepped orifice when possible can provide many benefits to the dry pipe sprinkler system designer and end user of the system, especially in critical mission areas, data centers, and telecommunication facilities. The benefits include an increased speed of water delivery which may help satisfy the requirements of NFPA 13. Water will be delivered to the fire faster and faster fire control may prevent additional sprinklers from operating, reducing potential water damage. Specifying sprinklers that use a stepped orifice adds a level of confidence that good practice is being used on dry pipe fire protection systems that require faster water delivery times to be achieved. The use of existing stepped orifice sprinklers provides for hydraulic calculations, listings and approvals that do not change and no additional steps need to be taken during the construction process.

### EXPERIMENTS AND RESULTS

Several experiments were conducted to measure the benefits of a stepped orifice sprinkler in a dry-pipe sprinkler system. Computer simulation was used to determine the comparison data. Field measurements of actual dry valve trip tests were conducted to confirm the simulation results. The experiments were conducted on a 1250-gallon side-fed tree system.

Water delivery times in an inspector's test were determined at several pressures, with and without an accelerator. For calculation purposes, the dry valve ratio was set at 5.75 and the accelerator was set to operate after a 2 PSI reduction in system pressure. These settings correlate well with the field results. The initial air pressure for testing without an accelerator varied from 15 to 40 PSI in 5 PSI increments. The initial air pressure for tests conducted with an accelerator varied from 15 to 50 PSI in 5 PSI increments.

In general terms, the stepped orifice has a significant advantage in the valve trip time when no accelerator is used. When an accelerator is used, the stepped orifice has an advantage because it can relieve air more quickly allowing water to enter the system.

In tests conducted without an accelerator, the main advantage of the stepped orifice is its ability to reach the valve trip time approximately 25% faster. After the valve trips, the water has to transit from the valve to the inspector's test. There are several factors that affect the transit time: water supply curve, friction loss, pipe size, system configuration and the ability to expel the remaining air out of the system to make room for water. Since the stepped orifice is better at relieving air, the water transit time for a stepped orifice is about 10% faster.

In tests where an accelerator is used, the air pressure when the valve opens varies with the initial pressure. A typical scenario using an accelerator is an initial air pressure of 35 PSI and the valve tripping at 33 PSI. The stepped orifice does not have a significant advantage over the tapered orifice in valve trip time. When an accelerator is used, the valve trip time is faster and the difference between the stepped orifice and the tapered orifice is only a few seconds. However, the incoming water sees a significant back pressure of 33 PSI and the incoming flow of water is partly limited to how fast air can be removed from the system to make room for the water. The advantage of the stepped orifice over the tapered orifice varies depending on the initial air pressure. At low initial air pressures (with accelerator), the stepped orifice gives a 10% advantage; at higher initial air pressures the stepped orifice gives as much as an 18% advantage in water delivery time.

Table 2 below shows the actual advantage of using the stepped orifice at several pressures. The water delivery time improvement includes the two components of valve trip time and water transit time. The water delivery time is the sum of the valve trip time and water transit time.

TABLE 2
Research 8.0K Stepped Orifice
% Advantage over Tapered Orifice
8.0K Water Deliver Time

| | |
|---|---|
| System | 1247 gallons |

| Pressure | No Accelerator | With Accelerator |
|---|---|---|
| 15 | 13.3% | 13.3% |
| 20 | 17.1% | 14.0% |
| 25 | 19.1% | 14.6% |
| 30 | 20.1% | 15.4% |
| 35 | 20.8% | 15.7% |
| 40 | 21.2% | 17.0% |

The present discovery may enable changing building codes to allow a larger dry pipe system if a stepped orifice is used. That is to say, the present discovery allows an increase in the current limit of a 500 gallon system to exceed 500 gallons, for example, 600 gallons, yet still have equivalent water delivery performance without a quick-opening device. The discovery further allows an increase of the 750 gallon limit with a quick-opening device to exceed 750 gallons, for example, 900 gallons. In both systems, this would represent a 20% increase in volume. The present disclosure provides the ability to construct larger systems with stepped orifice sprinklers versus tapered orifice sprinklers and still meet the 60 second water delivery requirement to the system test valve.

Double interlock preaction and dry pipe systems are more complex than typical wet sprinkler systems. Because of the inherent water delivery delay, good practice is critical when designing these systems. In addition to selecting sprinklers that use a stepped orifice, ensuring the inspector's test is sized and installed correctly, proper system maintenance and ensuring the requirement of NFPA 13 are followed will allow the best possible fire protection system to be installed.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A dry sprinkler system, comprising:
a pressurized fire extinguishing fluid source;
a fire extinguishing fluid supply line;
a plurality of fire protection sprinklers connected to said fire extinguishing fluid supply line, each of said plurality of fire protection sprinklers including a sprinkler body having a stepped orifice;
a control system operably connected to said pressurized fire extinguishing fluid source and said fire extinguishing fluid supply line, said control system configured to maintain said fire extinguishing fluid supply line dry during a non-activated condition and to forward a fire extinguishing fluid to said fire extinguishing fluid supply line from said pressurized fire extinguishing fluid source upon activation of one of said plurality of fire protection sprinklers.

2. A dry sprinkler system, comprising:
a pressurized fire extinguishing fluid source;
a fire extinguishing fluid supply line;
a plurality of fire protection sprinklers connected to said fire extinguishing fluid supply line, each of said plurality of fire protection sprinklers including a sprinkler body having a stepped orifice;
a control system operably connected to said pressurized fire extinguishing fluid source and said fire extinguishing fluid supply line, said control system configured to maintain said fire extinguishing fluid supply line dry during a non-activated condition and to forward a fire extinguishing fluid to said fire extinguishing fluid supply line from said pressurized fire extinguishing fluid source upon activation of one of said plurality of fire protection sprinklers, wherein said fire extinguishing fluid supply line has a volume greater than 500 gallons and said control system is free from a quick opening device.

3. A dry sprinkler system, comprising:
a pressurized fire extinguishing fluid source;
a fire extinguishing fluid supply line;
a plurality of fire protection sprinklers connected to said fire extinguishing fluid supply line, each of said plurality of fire protection sprinklers including a sprinkler body having a stepped orifice;
a control system operably connected to said pressurized fire extinguishing fluid source and said fire extinguishing fluid supply line, said control system configured to maintain said fire extinguishing fluid supply line dry during a non-activated condition and to forward a fire extinguishing fluid to said fire extinguishing fluid supply line from said pressurized fire extinguishing fluid source upon activation of one of said plurality of fire protection sprinklers, wherein said fire extinguishing fluid supply line has a volume greater than 750 gallons and said control system includes a quick opening device.
